(19) United States
(12) Patent Application Publication
(10) Pub. No.: US 2026/0277079 A1
(43) Pub. Date: Sep. 17, 2026

(54) SCOPE MOUNT

(71) Applicant: Magview, LLC, Lake Oswego, OR (US)

(72) Inventors: Jacob Borntrager, Canby, OR (US); Brice Shippen, Mt Angel, OR (US)

(21) Appl. No.: 19/079,136

(22) Filed: Mar. 13, 2025

(51) Int. Cl. G03B 13/16; G02B 23/14; G03B 13/10; G03B 17/56

(52) U.S. Cl. CPC G03B 13/16; G02B 23/14; G03B 13/10; G03B 17/565; G03B 17/566

(57) ABSTRACT

In some embodiments, an apparatus comprises a body arranged to engage an optical scope. The body comprises a first portion and a second portion moveable with respect to the first portion between a first position and a second position. The first portion comprises a sidewall defining an aperture having a central axis and the second portion comprises a magnet. In the first position, the second portion is arranged to cover the aperture and a radial distance from the central axis to the sidewall is greater than a radial distance from the central axis to the magnet.

### BACKGROUND

This invention relates generally to optical scopes and more specifically to mounts that allow an accessory, such as a recording device, to be used with an optical scope.

Optical scopes such as spotting scopes, binoculars and the like are generally known in the art and used to view objects at a distance. Users often have a desire to capture images and/or video of distant objects. During a hunting activity, users desire to capture recordings of a target before, during and after a shot. Certain users may have a desire to carry a minimal amount of equipment. In some cases, it is not practical to carry a large expensive camera or a dedicated zoom lens, but the user may have other recording devices available, such as a smartphone or action camera.

There remains a need for mount and adapter systems that allow commonly carried cameras to be used with optical scopes. There remains a need for image and video capture systems that are compatible with optical scopes.

All US patents and applications and all other published documents mentioned anywhere in this application are incorporated herein by reference in their entirety.

Without limiting the scope of the invention a brief summary of some of the claimed embodiments of the invention is set forth below. Additional details of the summarized embodiments of the invention and/or additional embodiments of the invention may be found in the Detailed Description of the Invention below.

A brief abstract of the technical disclosure in the specification is provided as well only for the purposes of complying with 37 C.F.R. 1.72. The abstract is not intended to be used for interpreting the scope of the claims.

### SUMMARY

In some embodiments, an apparatus comprises a body arranged to engage an optical scope. The body comprises a first portion and a second portion moveable with respect to the first portion between a first position and a second position. The first portion comprises a sidewall defining an aperture having a central axis and the second portion comprises a magnet. In the first position, the second portion is arranged to cover the aperture and a radial distance from the central axis to the sidewall is greater than a radial distance from the central axis to the magnet. In some embodiments, in the second position, the second portion does not cover the aperture.

In some embodiments, the body comprises a hinge between the first portion and the second portion.

In some embodiments, the body comprises a first position magnet arranged to bias the body to the first position.

In some embodiments, the body comprises a second position magnet arranged to bias the body to the second position.

In some embodiments, the first portion comprises an alignment surface and the second portion comprises a contacting surface that are aligned on a reference plane in the second position. In some embodiments, the alignment surface comprises a hinge knuckle.

In some embodiments, the first portion comprises a clamp arranged to reduce a diameter of the sidewall.

In some embodiments, the first portion comprises a focus adapter positioned between the front wall and the optical scope.

In some embodiments, the first portion comprises a sizing adapter positioned between the sidewall and the optical scope.

In some embodiments, the sizing adapter and the focus adapter comprise complimentary beveled surfaces arranged to contact one another.

In some embodiments, the mount is used with an accessory comprising a target and a lens, the magnet arranged to engage the target and retain the lens in alignment with the aperture.

In some embodiments, an apparatus comprises a body arranged to engage an optical scope. The body comprises an aperture and a plurality of magnets spaced around the aperture.

In some embodiments, the apparatus is used combination with an accessory comprising a target and a lens, the plurality of magnets arranged to engage the target and retain the lens in alignment with the aperture.

In some embodiments, the apparatus is used in combination with an accessory and a binocular, the accessory comprising a target and a lens, the binocular comprising a first scope and a second scope, the body engaged with the first scope, the target aligned with the first scope, the lens aligned with the second scope.

Another embodiment is a mount for aligning, via a target including a number of magnets, an optical device with a camera device including a camera having a lens. The mount broadly comprises a body including a first portion and a second portion. The first portion includes a sidewall and defines an aperture configured to be aligned with the lens of the camera. The second portion includes a number of magnets including a first set of magnets having a first polarity and a second set of magnets having a second polarity opposite the first polarity. The first set of magnets attract the magnets of the target and the second set of magnets repel the magnets of target such that the aperture aligns with the lens of the camera.

Another embodiment is a mount for aligning an optical device with a camera device including a camera having a lens. The mount broadly comprises a target including a number of magnets and configured to be attached to the camera device. The body is configured to engage the optical device and includes a first portion and a second portion. The first portion includes a sidewall and defines an aperture configured to be aligned with the lens of the camera. The second portion includes a number of magnets including a first set of magnets having a first polarity and a second set of magnets having a second polarity opposite the first polarity such that the first set of magnets attract the magnets of the target and the second set of magnets repel the magnets of the target so that the aperture aligns with the lens of the camera.

Another embodiment is a method of configuring a mount for aligning an optical device with a camera device. The method comprises steps of magnetically attaching a body of the mount to a target and aligning an aperture of the body of the mount with a lens of a camera of the camera device. The method further comprises steps of adjusting the body of the mount so that the target is near a side of the camera device while the aperture remains aligned with the lens, adhering the target to the side of the camera device, detaching the body of the mount from the target, and magnetically reattaching the body of the mount to the target so that the aperture automatically re-aligns with the lens.

These and other embodiments which characterize the invention are pointed out with particularity in the claims annexed hereto and forming a part hereof. However, for a better understanding of the invention, its advantages and objectives obtained by its use, reference can be made to the drawings which form a further part hereof and the accompanying descriptive matter, in which there are illustrated and described various embodiments of the invention.

### DRAWINGS

A detailed description of the invention is hereafter described with specific reference being made to the drawings.

FIG. 1 shows an embodiment of a mount orienting an accessory with respect to an optical scope;

FIG. 2 shows an embodiment of a mount engaged with an embodiment of an optical scope;

FIG. 3 shows the mount of FIG. 2 in another orientation;

FIGS. 4 and 5 show an exploded views of an embodiment of a mount;

FIGS. 6-8 show an embodiment of an adjustable size mount;

FIG. 9 shows another embodiment of a mount and optical scope;

FIG. 10 shows an exploded view of the mount of FIG. 9;

FIG. 11 shows an exploded view of the optical scope of FIGS. 9 and 10 with an accessory;

FIG. 12 shows another embodiment of an optical scope, mount and accessory;

FIG. 13 shows an exploded view of the components shown in FIG. 12;

FIGS. 14 and 15 show another embodiment of a mount;

FIG. 16 shows an exploded view of the mount shown in FIGS. 14 and 15;

FIG. 17 shows an exploded view of another embodiment of a mount;

FIG. 18 shows a cross-sectional view of the embodiment of a mount shown in FIG. 17;

FIG. 19 shows a perspective view of a mount constructed in accordance with another embodiment of the invention;

FIG. 20 shows a plan view of the mount of FIG. 19;

FIG. 21 shows an elevation view of the mount of FIG. 19; and

FIG. 22 shows an exploded view of the mount of FIG. 19.

### DETAILED DESCRIPTION

While this invention may be embodied in many different forms, there are described in detail herein specific embodiments of the invention. This description is an exemplification of the principles of the invention and is not intended to limit the invention to the particular embodiments illustrated.

For the purposes of this disclosure, like reference numerals in the figures shall refer to like features unless otherwise indicated.

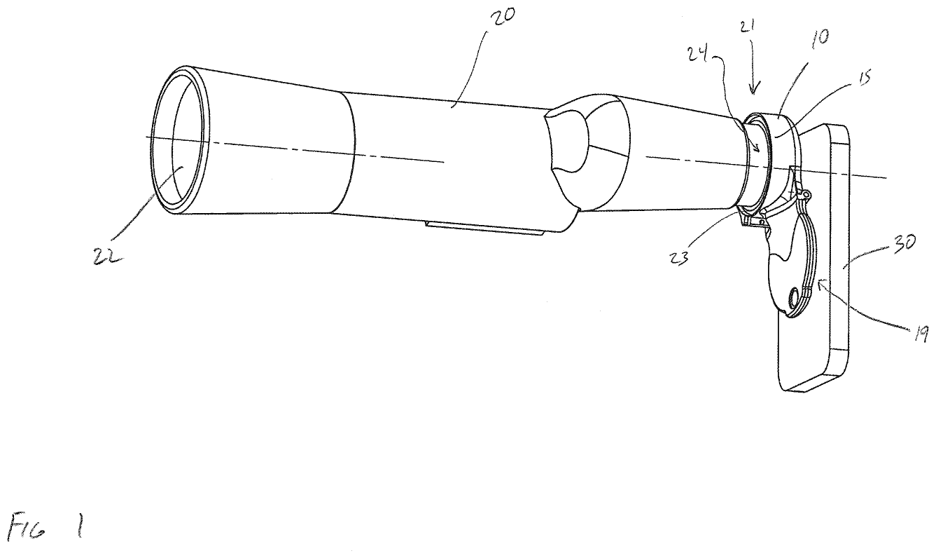

FIG. 1 shows an embodiment of a mount 10 being used in conjunction with an embodiment of an optical scope 20 and an embodiment of an accessory 30. In some embodiments, an optical scope 20 comprises a monocular or a spotting scope. In some embodiments, an optical scope 20 comprises an objective lens 22 and an ocular lens 24. A user will typically position their eye near the ocular lens 24 and look through the optical scope 20 to view a distant object.

In some embodiments, an optical scope 20 comprises an end portion 21 and an ocular lens 24 is located at or near the end portion 21.

In some embodiments, a mount 10 is arranged to engage the optical scope 20. In some embodiments, the mount 10 is arranged to engage the end portion 21 of the optical scope 20. In some embodiments, the mount 10 is arranged to engage an eye cup 23 positioned at the end portion 21.

In some embodiments, the mount 10 is arranged to engage the accessory 30 and position the accessory 30 with respect to the optical scope 20. In some embodiments, the accessory 30 comprises an image capturing device comprising a lens, and the mount 10 positions the lens of the accessory 30 in alignment with the ocular lens 24 of the optical scope 20.

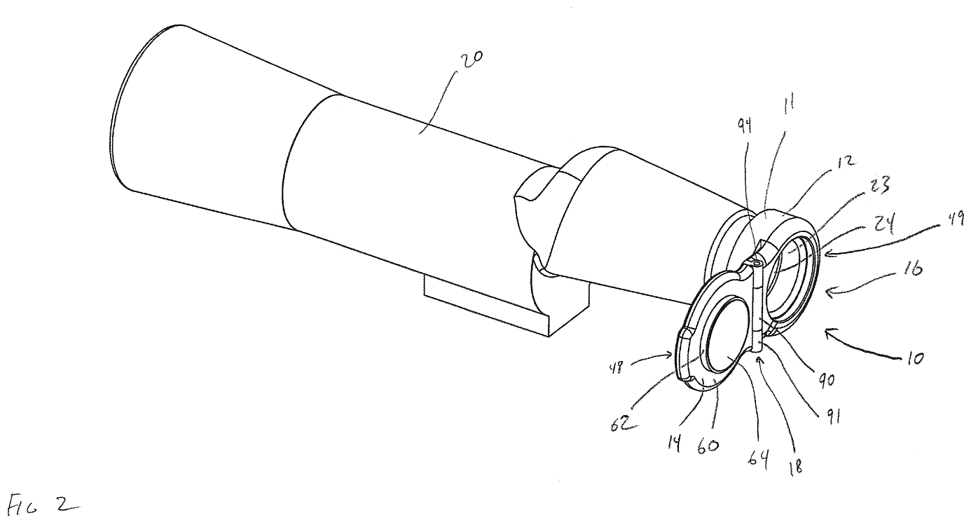

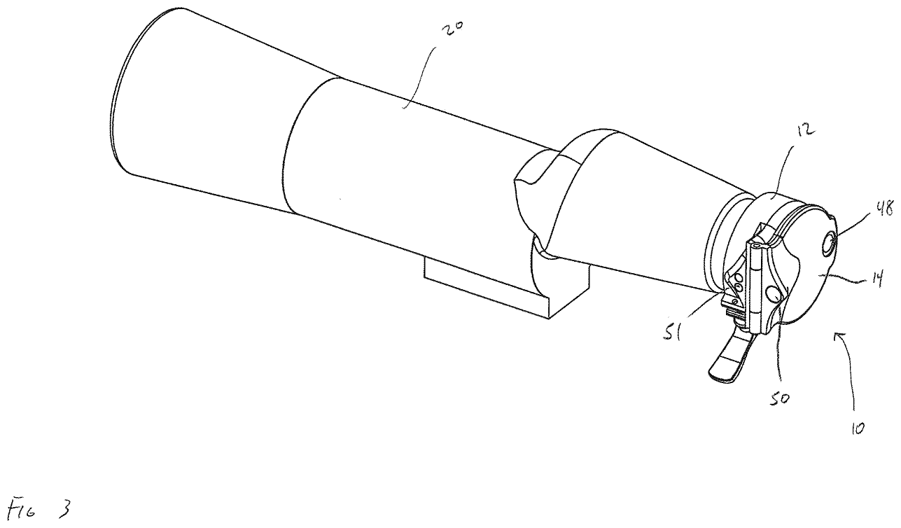

FIG. 2 shows an embodiment of a mount 10 engaged with an optical scope 20, with the mount 10 in an open configuration. FIG. 3 shows an embodiment of a mount 10 engaged with an optical scope 20 in a closed configuration. In some embodiments, the mount 10 comprises a lens cover.

In some embodiments, a mount 10 comprises a body 11 comprising a first portion 12 and a second portion 14. In some embodiments, the first portion 12 is moveable with respect to the second portion 14. In some embodiments, the mount 10 comprises a hinge 18 and the first portion 12 is moveable with respect to the second portion 14 about an axis of the hinge 18. In some embodiments, the hinge 18 comprises a first knuckle 90 and a second knuckle 91 engaged with a pin 94. In some embodiments, the first portion 12 comprises the first knuckle 90 and the second portion 14 comprises the second knuckle 91.

In some embodiments, the first portion 12 comprises an aperture 16. In some embodiments, the first portion 12 is arranged to engage an eye cup 23 of the optical scope 20. In some embodiments, the ocular lens 24 of the optical scope 20 is visible through the aperture 16.

In some embodiments, the mount 10 comprises a first orientation wherein the second portion 14 is in a first position with respect to the first portion 12. In some embodiments, the first orientation comprises a closed orientation and the second portion 14 is arranged to cover the aperture 16, for example as shown in FIG. 3. In some embodiments, the mount 10 comprises a second orientation wherein the second portion 14 is in a second position with respect to the first portion 12. In some embodiments, the second orientation comprises an open orientation and the second portion 14 does not cover the aperture 16, for example as shown in FIG. 2. In some embodiments, in the second orientation, the central axis of the aperture 16 does not intersect the second portion 14.

In some embodiments, the second portion 14 rotates approximately 180 degrees between the first orientation and the second orientation.

In some embodiments, the mount 10 comprises a retaining system arranged to retain the mount 10 in the first orientation. In some embodiments, a first retaining system is arranged to retain the mount 10 in the first orientation. In some embodiments, the first retaining system comprises a magnet 48 and a magnetically attractive target 49. In some embodiments, the magnet 48 is attached to the second portion 14 and the target 49 is attached to the first portion 12, or vice versa. In some embodiments, the target 49 comprises a ferrous material. In some embodiments, the target 49 comprises a magnet. In some embodiments, the magnet 48 and target 49 are hidden in cavities formed in the respective first portion 12 and second portion 14. In some embodiments, the magnet 48 and target 49 of the first retaining system are spaced apart from one another when the mount 10 is in the second orientation (see FIG. 2) and are close to one another (e.g. magnetically engaged) when the mount 10 is in the first orientation (see FIG. 3).

In some embodiments, in the first orientation, a distance from the central axis of the aperture 16 to the sidewall of the first portion 12 is greater than a distance from the central axis to the magnet 44.

In some embodiments, the mount 10 comprises a retaining system arranged to retain the mount 10 in the second orientation. In some embodiments, a second retaining system is arranged to retain the mount 10 in the second orientation. In some embodiments, the second retaining system comprises a magnet 50 and a magnetically attractive target 51. In some embodiments, the magnet 50 is attached to the second portion 14 and the target 51 is attached to the first portion 12, or vice versa. In some embodiments, the target 51 comprises a ferrous material. In some embodiments, the target 51 comprises a magnet. In some embodiments, the magnet 50 and target 51 are hidden in cavities formed in the respective first portion 12 and second portion 14. In some embodiments, the magnet 50 and target 51 of the second retaining system are spaced apart from one another when the mount 10 is in the first orientation (see FIG. 3) and are close to one another (e.g. magnetically engaged) when the mount 10 is in the second orientation (see FIG. 2).

In some embodiments, the first portion 12 comprises a material that is not magnetically attractive, such as a non-ferrous material. In some embodiments, the second portion 14 comprises a material that is not magnetically attractive, such as a non-ferrous material.

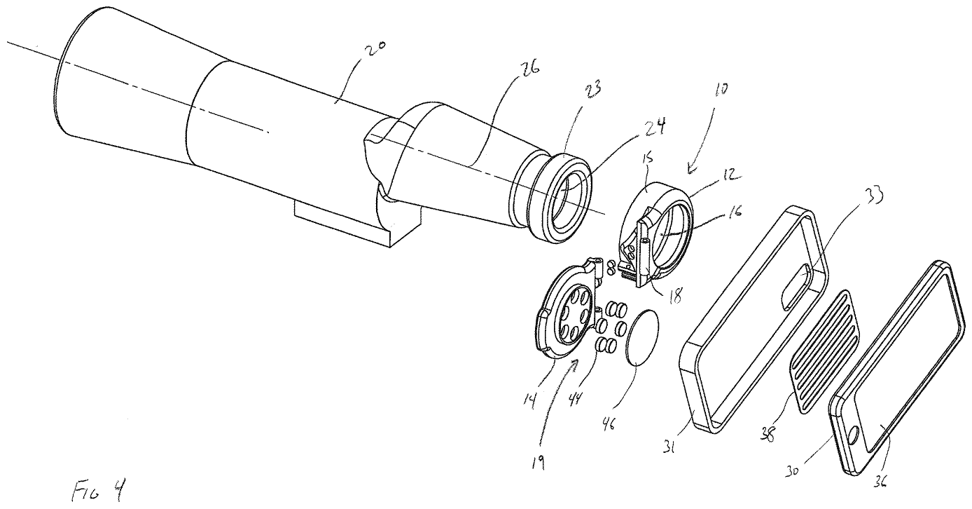

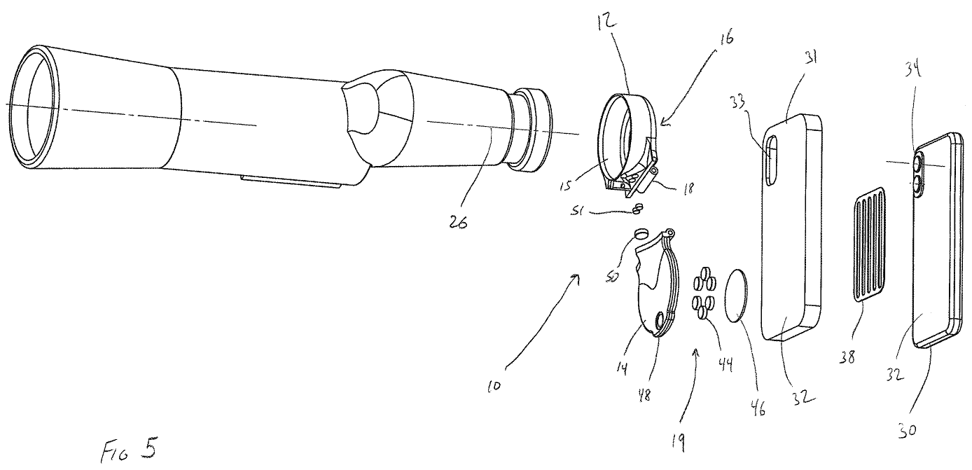

FIGS. 4 and 5 show exploded views of embodiments of items shown in FIG. 1. In some embodiments, the mount 10 comprises an engagement system 19 arranged to engage an accessory 30. In some embodiments, an engagement system 19 comprises a magnet 44 arranged to attract the accessory 30. In some embodiments, an engagement system 19 further comprises a target 38 arranged to magnetically engage the magnet 44. In some embodiments, the target 38 comprises a magnetically attractive material, such as a ferrous material. In some embodiments, the accessory 30 comprises the target 38, and the mount 10 is magnetically attracted to the target 38.

In some embodiments, the accessory 30 comprises a camera or another suitable device capable of capturing images, audio and/or video. In some embodiments, the accessory 30 comprises a smartphone comprising a touchscreen. In some embodiments, the accessory 30 comprises a lens 34. In some embodiments, the lens 34 extends from a surface 32 (e.g. a back surface) of the accessory 30. In some embodiments, the target 38 is positioned near the surface 32 adjacent to the lens 34. In some embodiments, the target 38 is attached to the surface 32. In some embodiments, the accessory 30 comprises a case 31. In some embodiments, a case 31 surrounds at least a portion of the accessory 30. In some embodiments, a case 31 comprises an aperture 33 and the lens 34 extends through the aperture 33 or is positioned to view through the aperture 33. In some embodiments, a target 38 is hidden within the case 31.

In some embodiments, the first portion 12 of the mount 10 comprises an aperture 16 and the second portion 14 comprises an engagement system 19 such as a magnet 44. In some embodiments, the aperture 16 is located adjacent to the magnet 44. In some embodiments, the accessory 30 comprises a target 38 adjacent to a lens 34. In some embodiments, the mount 10 is arranged to engage the accessory 30 with the lens 34 aligned with the aperture 16.

In some embodiments, the optical scope 20 defines an axis 26 that comprises a viewing axis. In some embodiments, the ocular lens 24 is oriented upon the axis 26. In some embodiments, the mount 10 engages the optical scope 20 with a central axis of the aperture 16 aligned upon the axis 26. In some embodiments, the mount 10 engages the accessory 30 with a central axis of the lens 34 aligned upon the axis 26. Thus, the mount 10 can engage an accessory 30, such as a smartphone, and hold the accessory 30 in place with a camera lens 34 arranged to look through the optical scope 20. The accessory 30 can then be used to capture images and video of faraway objects.

In some embodiments, an object of the mount 10 is to provide a fast and easy way to properly orient and attach the accessory 30 to the optical scope 20. In some embodiments, an object of the mount 10 is to allow a user to capture images/video through the optical scope 20 with equipment the user ordinarily carries (e.g. phone) while not requiring a stand-alone camera.

In some embodiments, the engagement system 19 comprises multiple magnets 44. Any suitable number of magnets 44 can be used. In some embodiments, the magnets 44 are equally spaced about an axis. In some embodiments, the magnets are equally spaced about a central axis of the aperture 16 when the mount 10 is in the first orientation (e.g. closed, for example as shown in FIG. 3).

In some embodiments, the second portion 14 comprises a plurality of cavities. In some embodiments, each cavity houses a magnet 44.

In some embodiments, the use of multiple magnets 44 allows more flexibility in the specific location(s) of the accessory 30/target 38 with respect to the magnets 44. For example, a single magnet may tend to self-center on the target 38, whereas multiple magnets 44 can allow for additional retention orientations for the accessory 30. The use of a greater number of magnets 44 can allow for greater degrees of freedom in the specific placement of the accessory 30 with respect to the aperture 16, which can allow a given mount 10 to be used with multiple versions of accessories 30 (e.g. various smartphone models), which may have different sizes and different lens 34 locations.

In some embodiments, the second portion 14 of the mount 10 comprises an abutting surface 60 and a flange 62 raised above the abutting surface 60. In some embodiments, the abutting surface 60 is arranged to contact the first portion 12 when the mount 10 is in the first orientation. In some embodiments, the flange 62 extends into the aperture 16 when the mount 10 is in the first orientation. In some embodiments, the flange 62 is sized to frictionally engage a surface of the first portion 12 that defines the aperture 16.

In some embodiments, one or more magnets 44 are oriented in the flange 62. In some embodiments, the mount 10 comprises a cover 46 positioned over the magnet(s) 44. In some embodiments, a cover 46 comprises a polymeric material. In some embodiments, a cover 46 comprises an elastomeric material. In some embodiments, a cover 46 comprises a bumper arranged to quiet audible noise that might be generated as the mount 10 engages an accessory 30.

In some embodiments, an accessory 30 comprises a surface 32 that defines a plane. In some embodiments, a case 31 comprises the surface 32. In some embodiments, the mount 10 comprises one or more portions aligned on a reference plane and arranged to abut the surface 32 of the accessory 30. In some embodiments, the second portion 14 comprises a contacting surface 64 arranged to contact the accessory 30. In some embodiments, the flange 62 comprises the contacting surface 64. In some embodiments, the contacting surface 64 comprises the cover 46. In some embodiments, the contacting surface 64 defines a reference plane. In some embodiments, the first portion 12 comprises an alignment surface that is also located on the reference plane. In some embodiments, a surface of the hinge 18 comprises an alignment surface. In some embodiments, a hinge knuckle 90 comprises the alignment surface. Thus, in some embodiments, an exterior surface of the hinge 18 structure is used as an orientation member for the accessory 30.

In some embodiments, a target 38 can have any suitable size, shape and configuration. In some embodiments, a target 38 comprises a solid metal plate. In some embodiments, a target 38 comprises apertures, slots or the like arranged in any suitable pattern. In some embodiments, a target 38 comprises a mesh material. In some embodiments, a target 38 comprises a grate. In some embodiments, a target 38 comprises ferric material suspended in another material, such as a cured mixture of iron powder and epoxy. Any suitable ratio of ferric material and epoxy can be used. In some embodiments, iron powder comprises 65% to 75% of a mixture by weight, with the remainder comprising a curable epoxy. In some embodiments, a curable epoxy comprises 105 Epoxy Resin and 206 Slow Hardener available from West System, 100 Patterson Ave., Bay City, Mich. In some embodiments, a target 38 is capable of magnetically engaging a mount 10 and supporting an attached accessory 30. In some embodiments, an accessory 30 is capable of wireless charging and wireless charging can occur through the target 38.

In some embodiments, a mount 10 comprises a sidewall 15 arranged to contact and engage an optical scope 20. In some embodiments, a first portion 12 of the mount 10 comprises a sidewall 15. In some embodiments, the sidewall 15 is arranged to contact and engage an eye cup 23 of an optical scope 20. In some embodiments, the sidewall 15 surrounds the eye cup 23. In some embodiments, a sidewall 15 comprises a fixed size and configuration. In some embodiments, a sidewall 15 is arranged to frictionally engage an optical scope 20.

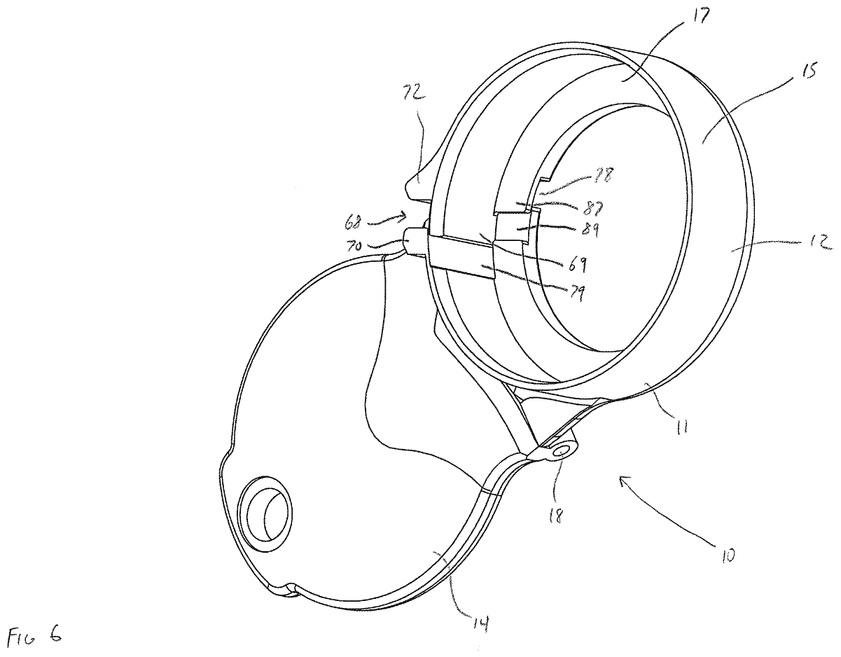

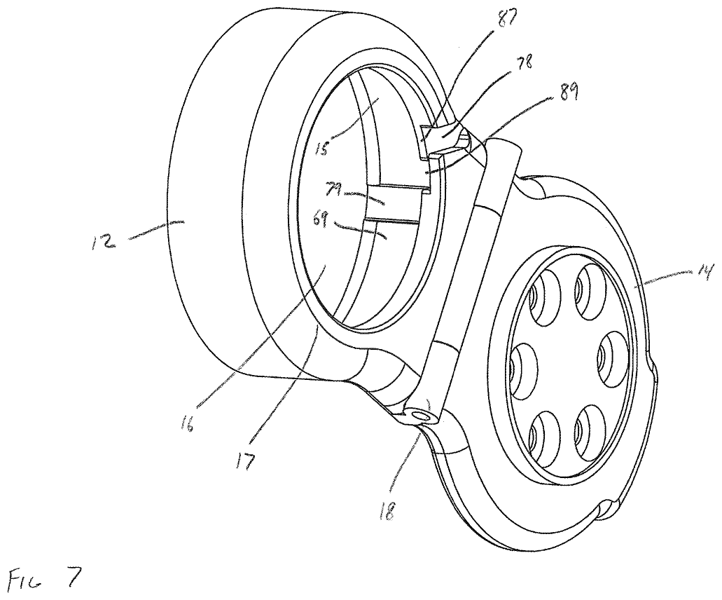

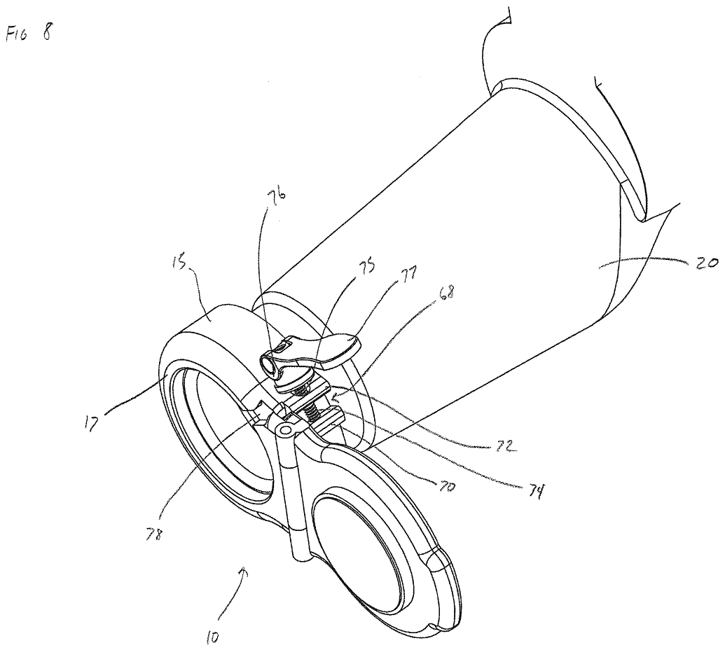

Referring to FIGS. 6-8, an embodiment of a mount 10 is shown. In some embodiments, a size of the mount 10 is adjustable. In some embodiments, a size of the sidewall 15 is adjustable. In some embodiments, the sidewall 15 comprises a circular shape and a diameter of the circular shape is adjustable. In some embodiments, the sidewall 15 defines a gap 68. In some embodiments, a size of the gap 68 can be adjusted to adjust the size of the sidewall 15. In some embodiments, the first portion 12 comprises a clamp and the size of the gap 68 is adjustable.

In some embodiments, a mount 10 comprises a first boss 70 and a second boss 72. In some embodiments, the first boss 70 and second boss 72 are located on opposite sides of the gap 68. In some embodiments, the first boss 70 and the second boss 72 define the gap 68. In some embodiments, the sidewall 15 comprises the first boss 70 and the second boss 72.

In some embodiments, a fastener 74 is arranged to adjust a size of the gap 68. In some embodiments, the fastener 74 is engaged with the first boss 70 and the second boss 72. In some embodiments, the fastener 74 is arranged to threadably engage the first boss 70. In some embodiments, the fastener 74 is arranged to abut the second boss 72. In some embodiments, the second boss 72 comprises an aperture and the fastener 74 extends through the aperture. Thus, in some embodiments, adjusting the fastener 74 will change the size of the gap 68.

In some embodiments, a mount 10 comprises a cam lock 76. In some embodiments, a cam lock 76 comprises a handle 77. In some embodiments, the handle 77 can be moved to actuate the cam lock 76. In some embodiments, the cam lock 76 comprises a quick release mechanism that can adjust a size of the gap 68. In some embodiments, a fastener 74 comprises a cam lock 76. In some embodiments, a fastener 74 comprises the handle 77.

In some embodiments, the mount 10 comprises a cover 69 arranged to cover the gap 68. In some embodiments, a cover 69 prevents dust from entering an interior portion of the mount 10. In some embodiments, the sidewall 15 comprises the cover 69. In some embodiments, the sidewall 15 comprises a recess 79. In some embodiments, a varying amount of the cover 69 is oriented in the recess 79 as a size of the gap 68 is adjusted.

In some embodiments, the mount 10 comprises a front wall 17. In some embodiments, the front wall 17 is oriented generally perpendicular to the sidewall 15. In some embodiments, the front wall 17 extends inwardly from the sidewall 15. In some embodiments, the front wall 17 defines the aperture 16.

In some embodiments, the front wall 17 comprises a gap 78. In some embodiments, a gap 68 in the sidewall 15 comprises a first gap 68 and the gap 78 in the front wall 17 comprises a second gap 78. In some embodiments, the second gap 78 is offset from the first gap 68. For example, in some embodiments, the first gap 68 and the second gap 78 are located along different radial vectors extending from a central axis of the aperture 16.

In some embodiments, the mount 10 comprises a cover 87 arranged to cover the gap 78. In some embodiments, a cover 87 prevents dust from entering an interior portion of the mount 10. In some embodiments, the front wall 17 comprises the cover 87. In some embodiments, the front wall 17 comprises a recess 89. In some embodiments, a varying amount of the cover 87 is oriented in the recess 89 as a size of the gap 78 is adjusted. In some embodiments, the cover 87 comprises a second cover and the recess 89 comprises a second recess.

In some embodiments, the sidewall 15 and front wall 17 are fixedly attached or integral to one another. In some embodiments, the sidewall 15 and the wall 17 are defined by a single piece of material. In some embodiments, adjustment of a size of the first gap 68 will cause a change in the size of the second gap 78.

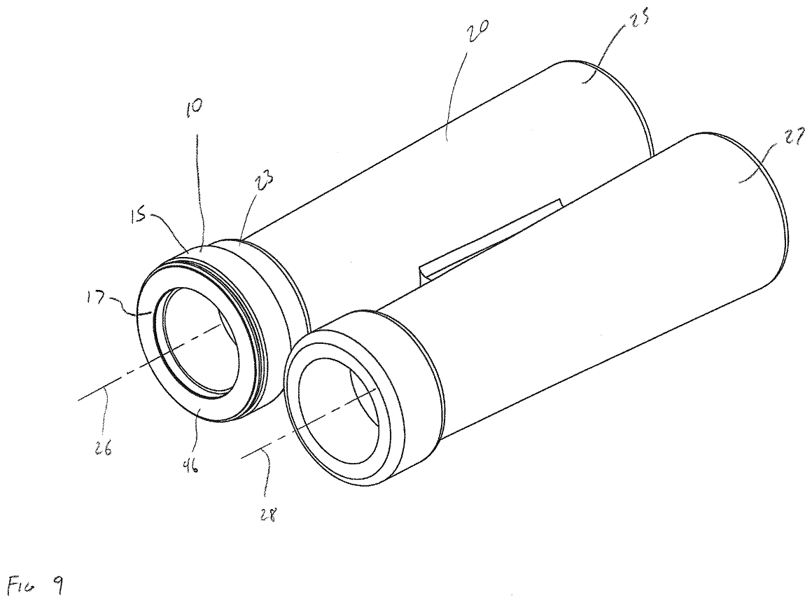

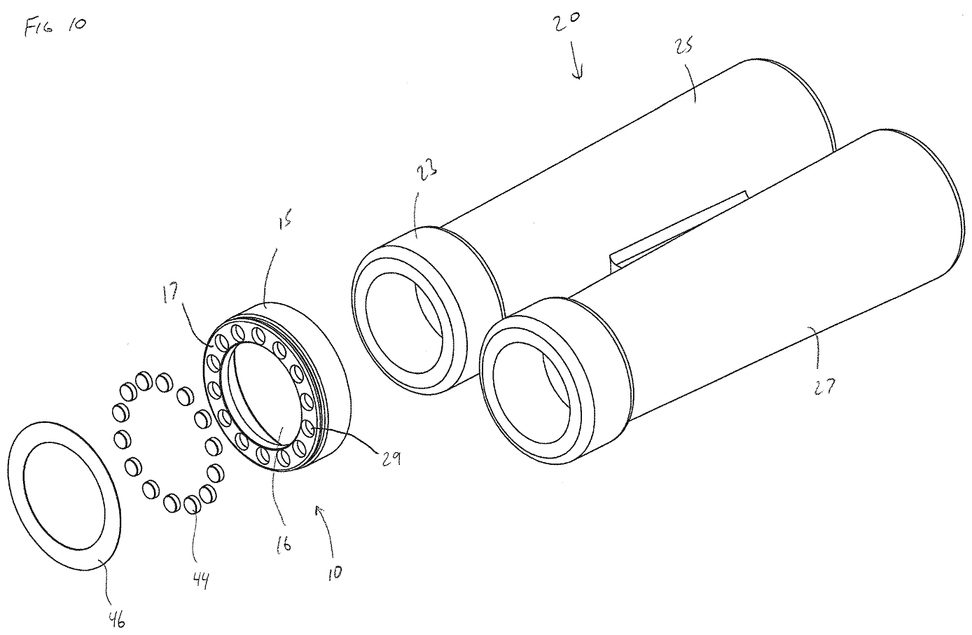

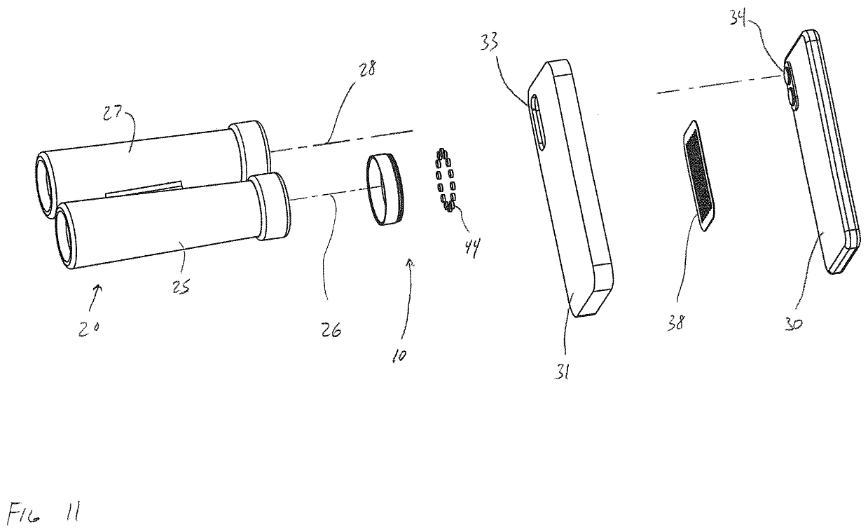

FIGS. 9-11 show another embodiment of a mount 10. In some embodiments, a mount 10 is suitable for use with an optical scope 20 comprising a first scope 25 and a second scope 27, such as a binocular. In some embodiments, the first scope 25 is arranged on a first axis 26 and the second scope 27 is arranged on a second axis 28.

In some embodiments, a mount 10 comprises a sidewall 15 and a front wall 17. In some embodiments, the mount 10 comprises a plurality of magnets 44. In some embodiments, magnets 44 are contained in the front wall 17. In some embodiments, the front wall 17 comprises a plurality of cavities 29 and each cavity 29 contains a magnet 44. In some embodiments, the mount 10 comprises an aperture 16 and the magnets 44 are equally spaced about the aperture 16.

In some embodiments, an accessory 30 can be engaged with the mount 10, wherein the mount 10 positions the accessory 30 with respect to the optical scope 20. In some embodiments, the mount 10 magnetically attracts a target plate 38 that is attached to the accessory 30. In some embodiments, the accessory 30 comprises a lens 34, and the target plate 38 is offset from the lens 34. In some embodiments, the accessory 30 is engaged with a mount 10 in proximity to a first scope 25 and a lens 34 of the accessory 30 is aligned with the second scope 27. In some embodiments, the lens 34 is aligned upon an axis 28 of the second scope 27. In some embodiments, an accessory 30 is engaged with a first scope 25 of a binocular and a lens 34 of the accessory 30 is arranged to view through a second scope 27 of the binocular.

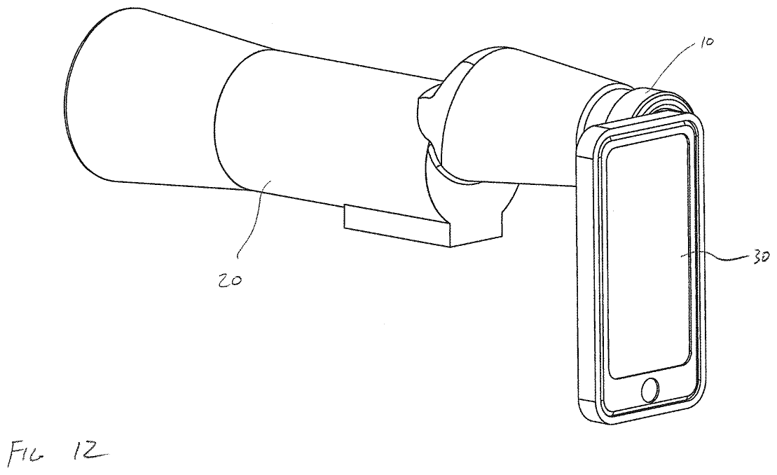

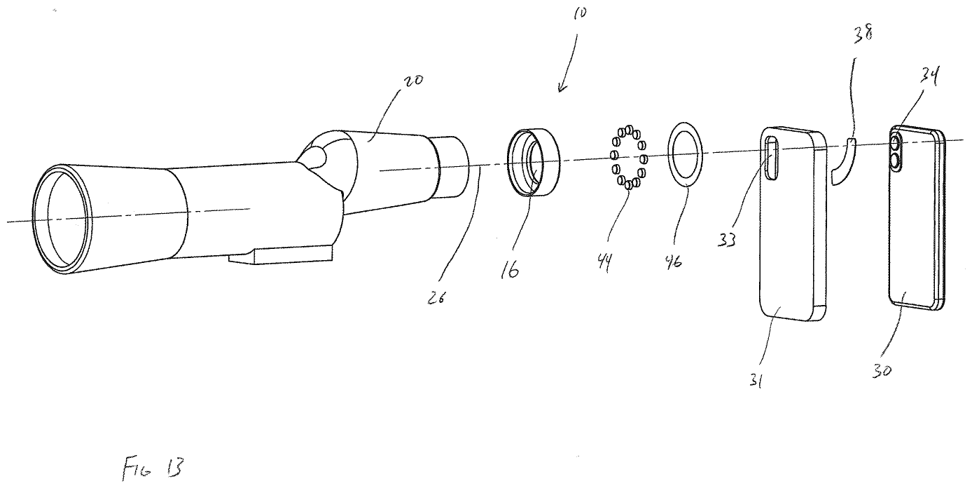

FIGS. 12 and 13 show another embodiment of a mount 10 and target plate 38. In some embodiments, a mount 10 comprises a plurality of magnets 44 disposed about an aperture 16. The aperture 16 can be aligned upon an axis 26 of an optical scope 20. In some embodiments, a target plate 38 is magnetically attracted to the mount 10. In some embodiments, the target plate 38 comprises a curved body. In some embodiments, the target plate 38 comprises an arcuate shape. In some embodiments, the target plate 38 comprises a semicircular shape. In some embodiments, the target plate 38 comprises a circular arc. In some embodiments, the target plate 38 extends around a lens 34 of the accessory 30. In some embodiments, the target plate 38 is concave with respect to the lens 34.

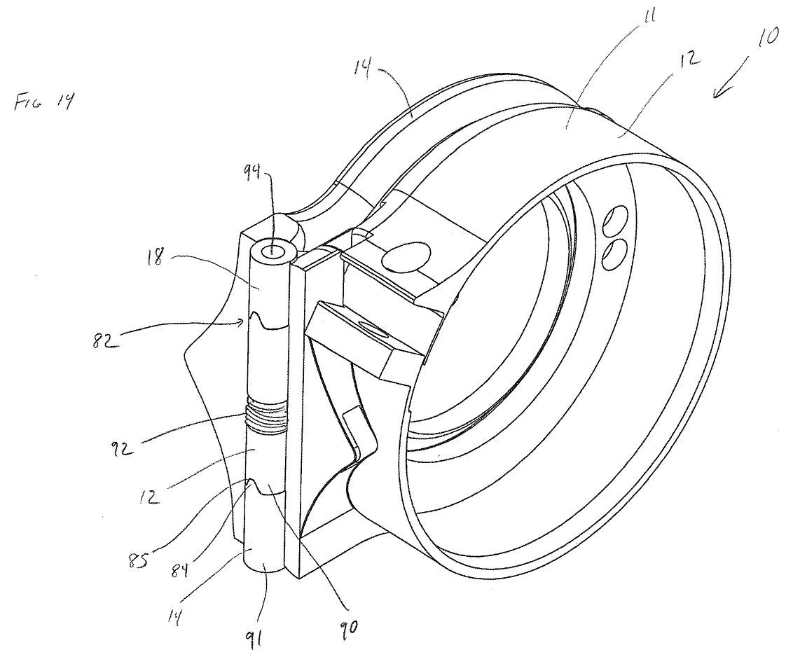

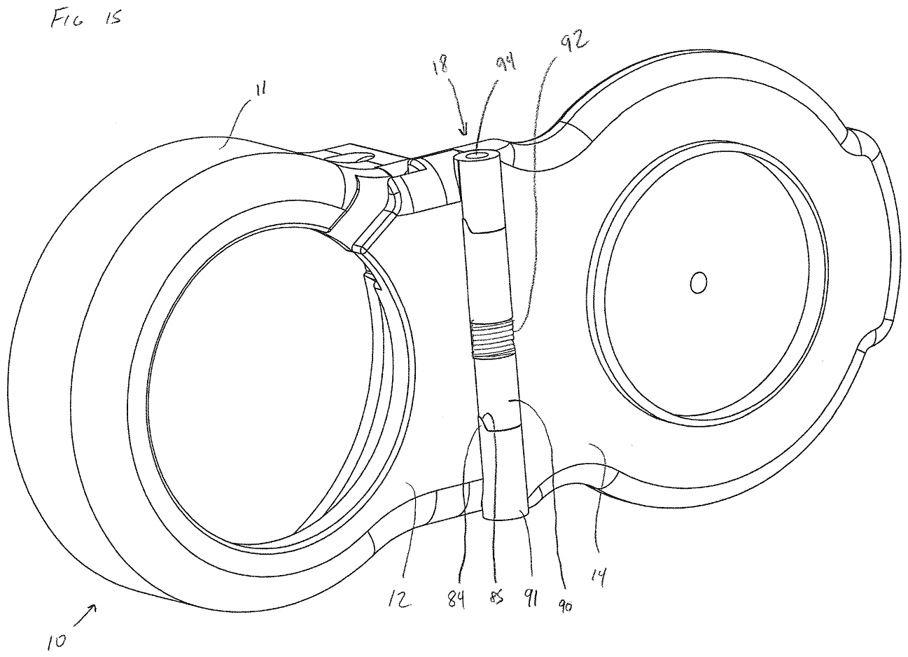

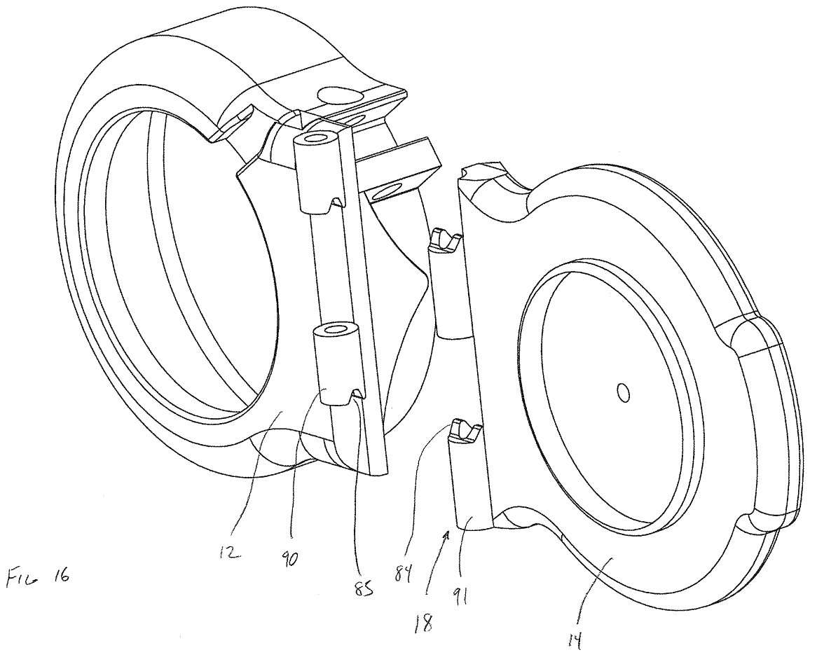

FIGS. 14-16 show another embodiment of a mount 10. In some embodiments, a mount 10 comprises a body 11 comprising a first portion 12 and a second portion 14 moveable with respect to the first portion 12. In some embodiments, the mount 10 comprises a detent 82 arranged to bias the first portion 12 and second portion 14 to a predetermined orientation with respect to one another. In some embodiments, a detent 82, or a plurality of detents 82, are arranged to bias the second portion 14 to one or more predetermined orientations with respect to the first portion 12.

In some embodiments, a detent 82 comprises an interface between the first portion 12 and the second portion 14. In some embodiments, a detent 82 comprises a peak 84 arranged to be received in a valley 85. In some embodiments, a peak 84 comprises a protrusion and a valley 85 comprises a recess. In some embodiments, the second portion 14 comprises a peak 84 and the first portion 12 comprises a valley 85, or vice versa.

In some embodiments, the mount 10 comprises a biasing member 92 arranged to engage the detent 82. In some embodiments, a biasing member 92 is arranged to cause a peak 84 to engage with a valley 85. In some embodiments, a biasing member 92 causes a peak 84 to align upon and seat in a valley 85. In some embodiments, a biasing member 92 applies forces between the first portion 12 and the second portion 14. In some embodiments, a biasing member 92 comprises a spring. In some embodiments, a biasing member 92 comprises a coil spring.

In some embodiments, a hinge 18 comprises a pin 94 arranged to contact the first portion 12 and the second portion 14. In some embodiments, a biasing member 92 is arranged to surround the pin 94.

In some embodiments, a hinge 18 comprises a detent 82. In some embodiments, a hinge 18 comprises a knuckle 90, 91 and the knuckle 90, 91 comprises a detent 82. In some embodiments, the first portion 12 comprises a first knuckle 90 and the second portion 14 comprises a second knuckle 91. In some embodiments, a pin 94 engages the first knuckle 90 and the second knuckle 91. In some embodiments, the first knuckle 90 and the second knuckle 91 engage one another via a detent 82. In some embodiments, the first knuckle 90 comprises a valley 85 and the second knuckle 91 comprises a peak 84 arranged to nest in the valley 85. In some embodiments, a biasing member 92 applies forces to the first portion 12 and second portion 14 that encourage the peak 84 to nest in the valley 85. In some embodiments, moving the first portion 12 with respect to the second portion 14, for example via rotation about the hinge 18, causes a detent 82 to disengage. In some embodiments, moving the first portion 12 with respect to the second portion 14 causes a peak 84 to unseat from a valley 85. In some embodiments, the first portion 12 will move along an axis of the hinge 18 with respect to the second portion 14 as a detent 82 disengages. In some embodiments, disengagement of a detent 82 applies forces to the biasing member 92, for example compressing the biasing member 92.

In some embodiments, a first knuckle 90 comprises a plurality of detent 82 locations. In some embodiments, a second knuckle 91 comprises a plurality of complimentary detent 82 locations. In some embodiments, the detent locations and complimentary detent locations are equally spaced about a periphery of the knuckle 90, 91. In some embodiments, a first knuckle 90 comprises a plurality of valleys 85. In some embodiments, the valleys 85 are equally spaced around a central axis of the hinge 18. In some embodiments, the second knuckle 91 comprises a plurality of peaks 84. In some embodiments, the peaks 84 are equally spaced around a central axis of the hinge 18. In some embodiments, the number of peaks 84 is equal to the number of valleys 85. In some embodiments, the number of peaks 84 and valleys 85 is equal to the number of different orientations that the first portion 12 can be biased to with respect to the second portion 14. In some embodiments, the number of peaks 84 represents the number of detent stop positions available when the peaks 84 are seated in the various valleys 85.

In some embodiments, a mount 10 comprises both detents 82 and magnets 48, 50 as described herein.

In some embodiments, the concept of the mount 10 can be integrated into an optical scope 20. In some embodiments, an eye cup 23 of a scope 20 comprises features of a mount 10 as described herein, for example comprising a plurality of magnets 44 oriented around an aperture 16. In some embodiments, an eye cup 23 of a scope 20 comprises a first portion 12 and a second portion 14 as described herein.

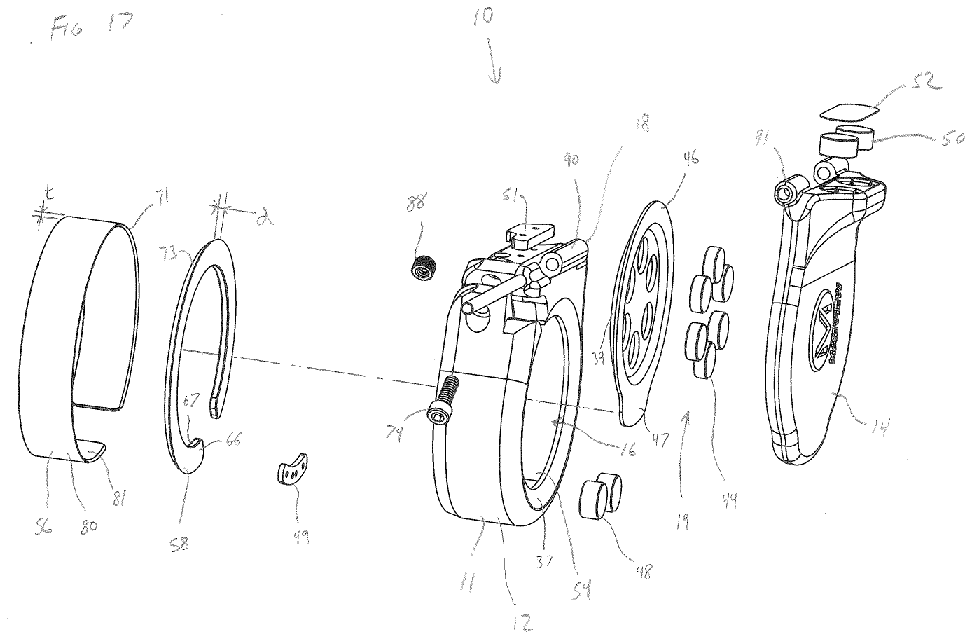

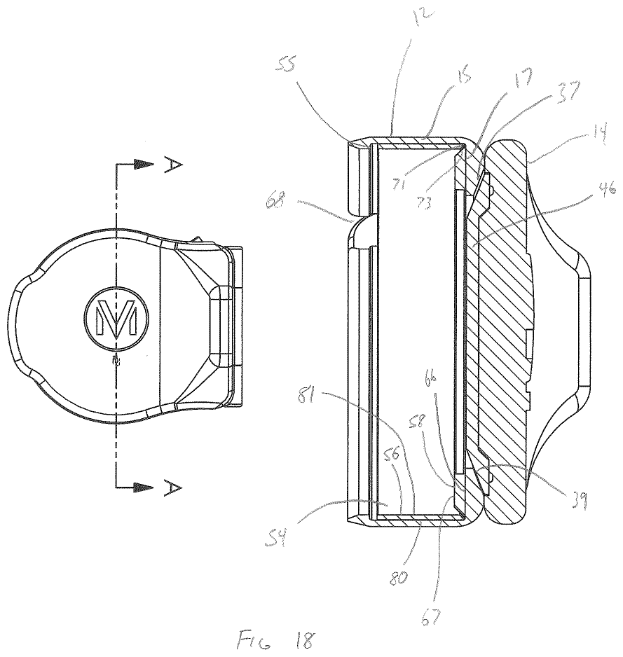

FIG. 17 shows an embodiment of a mount 10. FIG. 18 shows a cross-sectional view of the embodiment of a mount 10 shown in FIG. 17.

In some embodiments, a mount 10 comprises a sizing adapter 56. In some embodiments, a sizing adapter 56 can be positioned between the body 11 and an optical scope. For example, when using an optical scope having a relatively smaller diameter eye cup, a sizing adapter 56 can be oriented between the eye cup and the mount 10. In some embodiments, a sizing adapter 56 can be used to change an inner diameter of the first portion 12.

In some embodiments, a mount 10 comprises a focus adapter 58. In some embodiments, a focus adapter 58 can be positioned between the body 11 and an optical scope, for example to adjust a distance between the aperture 16 and the ocular lens of an optical scope.

In some embodiments, the mount 10 comprises a cavity 54. In some embodiments, the first portion 12 comprises the cavity 54. In some embodiments, the cavity 54 is defined by the sidewall 15. In some embodiments, the sidewall 15 comprises a flange 55 oriented opposite the front wall 17, and the cavity 54 is defined by the front wall 17 and flange 55. In some embodiments, the cavity 54 is annular and surrounds the aperture 16.

In some embodiments, a sizing adapter 56 can be used in the cavity 54 without a focus adapter 58. In some embodiments, a focus adapter 58 can be used in the cavity without a sizing adapter 56. In some embodiments, both a sizing adapter 56 and a focus adapter 58 can be used in the cavity 54 simultaneously.

In some embodiments, a sizing adapter 56 comprises a first surface 80 arranged to contact the first portion 12 and a second surface 81 arranged to contact an optical scope. In some embodiments, the first surface 80 comprises an outer surface and the second surface 81 comprises an inner surface. In some embodiments, a sizing adapter 56 comprises a circular shape. In some embodiments, a sizing adapter 56 surrounds the aperture 16.

In some embodiments, multiple sizing adapters 56 can be provided having different thicknesses t, allowing different sizing adapters 56 to be used with different optical scopes.

In some embodiments, a focus adapter 58 comprises a first surface 66 arranged to contact the first portion 12 and a second surface 67 arranged to contact an optical scope. In some embodiments, the first surface 66 contacts the front wall 17. In some embodiments, multiple focus adapters 58 can be provided having different depths d, allowing different focus adapters 58 to be used with different optical scopes and/or different accessories, smartphones, cameras, etc.

In some embodiments, a sizing adapter 56 comprises a bevel 71. In some embodiments, a focus adapter 58 comprises a complimentary bevel 73. In some embodiments, the bevel 71 of a sizing adapter 56 contacts the complimentary bevel 73 of a focus adapter 58. In some embodiments, the bevels 71, 73 prevent overlap and/or interference between a sizing adapter 56 and a focus adapter 58 oriented in the cavity 54. Thus, the bevels 71, 73 allow multiple sizing adapters 56 and multiple focus adapters 58 to be used interchangeably in the cavity 54 with proper fit between the cavity 54 and the adapters 56, 58.

The sizing adapters 56 and focus adapters 58 discussed with respect to FIGS. 17 and 18 can be used with any suitable embodiment of a mount 10 as disclosed herein.

In some embodiments, the mount 10 comprises a cover 52 positioned over the second position magnet(s) 50. In some embodiments, a cover 52 comprises a soft material arranged to prevent noise when the second position magnet(s) 50 engage their target 51. In some embodiments, a cover 52 is polymeric. In some embodiments, a cover 52 is elastomeric.

In some embodiments, the first portion 12 comprises a front bevel 37. In some embodiments, the front wall 17 comprises the front bevel 37. In some embodiments, the front bevel 37 is annular and surrounds the aperture 16. In some embodiments, the second portion 14 comprises a complimentary bevel 39. In some embodiments, the cover 46 comprises the complimentary bevel 39. In some embodiments, the front bevel 37 and complimentary bevel 39 are arranged to contact one another and provide a dust cover for the aperture 16 when the mount 10 is in the first/closed orientation.

In some embodiments, the cover 46 comprises an extension 47 arranged to cover the first position magnet(s) 48.

In some embodiments, the mount 10 comprises an adjustment fastener 74. In some embodiments, the mount 10 comprises a threaded receptacle 88 arranged to engage the fastener 74. In some embodiments, the threaded receptacle 88 is insert molded into the first portion 12. In some embodiments, the first position magnet target 49 is insert molded into the first portion 12. In some embodiments, the second position magnet target 51 is insert molded into the first portion 12.

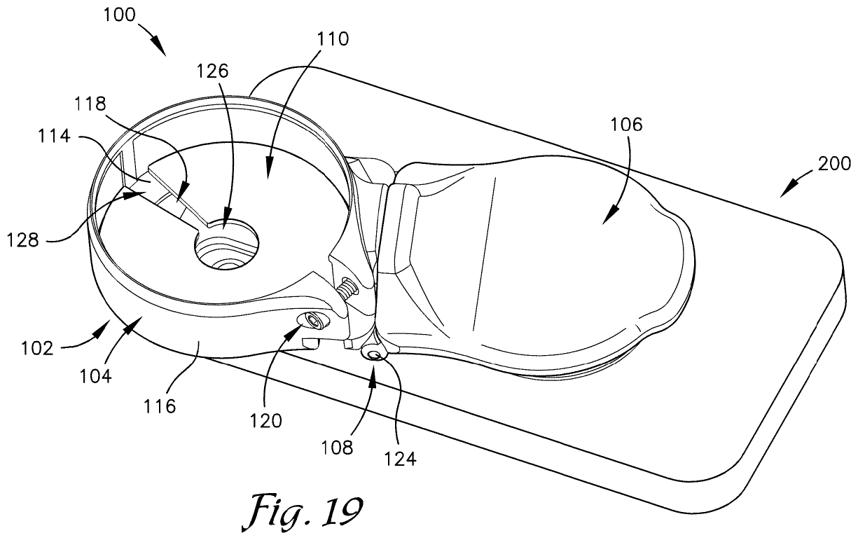

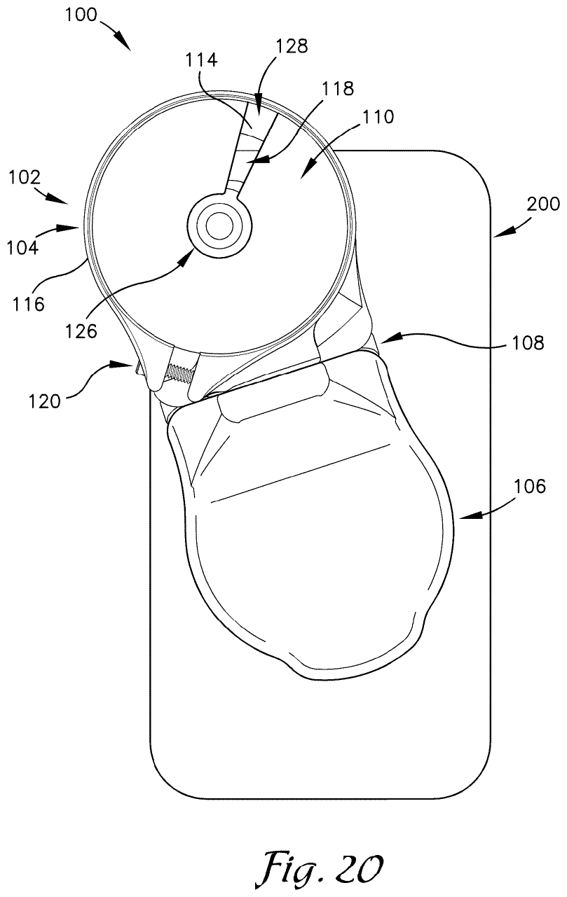

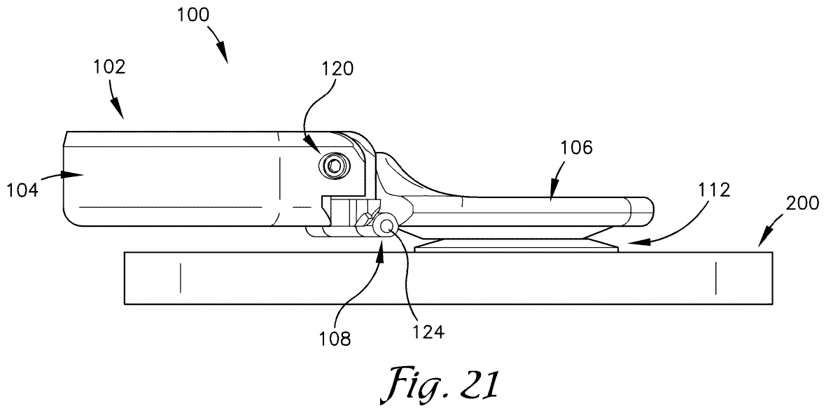

Turning to FIGS. 19-22, a mount 100 constructed in accordance with another embodiment of the invention will now be described. The mount 100 broadly comprises a body 102 including a first portion 104, a second portion 106, and a hinge 108 pivotably connecting the first portion 104 and the second portion 106. The mount 100 also comprises a guide 110 for aligning the mount 100 with a camera 202 of a camera device 200 (e.g., a cellular phone, tablet, or the like) and a target 112 for removably attaching the body 102 to the camera device 200. The mount 100 may be used to retain an optical device such as a spotting scope, a telescope, a set of binoculars, or the like in optical alignment with a lens 204 of the camera 202.

The first portion 104 includes an end wall 114 and a sidewall 116 forming an aperture 118 configured to be aligned with an ocular lens of the optical device. The end wall 114 may form a backstop for the ocular lens. The sidewall 116 may circumferentially confine the ocular lens thereby retaining the ocular lens in alignment with the aperture 118. The sidewall 116 may include an adjuster 120 configured to selectively increase or decrease the circumference of the sidewall 116. The adjuster 120 may include a threaded bolt, a sliding mechanism, or the like.

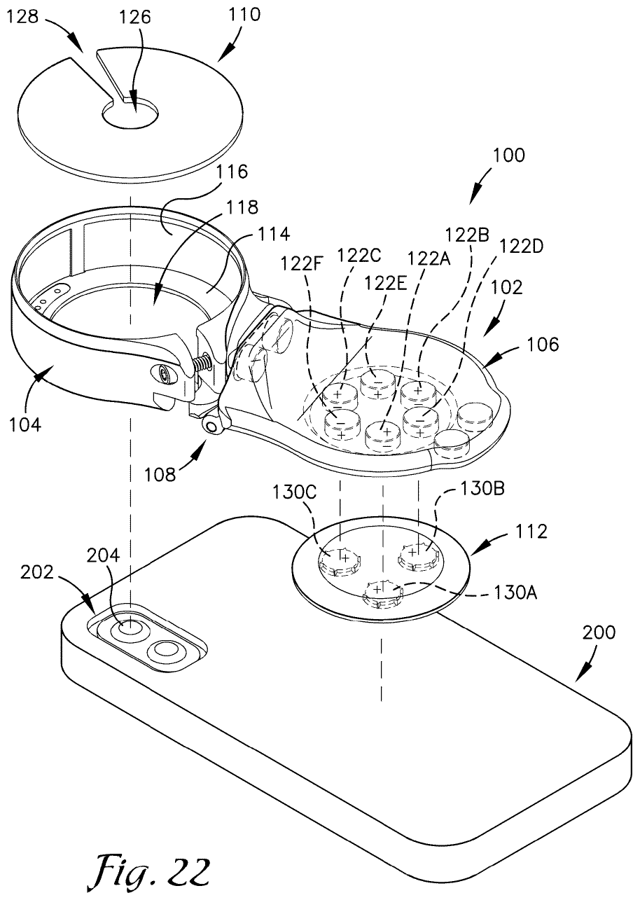

The second portion 106 may be pivotably connected to the first portion 104 via the hinge 108 and, as seen in FIG. 22, may include a plurality of magnets 122A-F configured to removably attach the mount 100 to the camera device 200 via the target 112. The second portion 106 may be configured to pivot between a first position and a second position. In the first position, the second portion is folded against the first portion 104 thereby covering the aperture 118. In the second position, the second portion 106 extends away from the first portion 104.

The magnets 122A-F may be arranged in a circular array as shown, although other arrangements are possible. For example, the magnets 122A-F could be arranged in a rectangular array, a linear array, a triangular array, or the like. The magnets 122A-F may include a first set of magnets 122A-C and a second set of magnets 122D-F. The first set of magnets 122A-C may all have the same polarity as each other and the second set of magnets 122D-F may have the same polarity as each other. Furthermore, the first set of magnets 122A-C may have opposite polarity as the magnets 122D-F. In one embodiment, the magnets 122A-F may alternate between magnets 122A-C and magnets 122D-F such that each magnet 122A-C is adjacent to two of magnets 122D-F and each magnet 122D-F is adjacent to two of magnets 122A-C. This pattern may wrap around in some arrays such as in the depicted circular array. In contrast, in some arrays, end, edge, or corner magnets may be adjacent to fewer opposite-polarity magnets than magnets in central portions of the array. In one embodiment, the magnets 122A-F have a thickness of approximately 1/32 inches. In another embodiment, the magnets 122A-F have a thickness of approximately 1/16 inches. Although six magnets are shown, other numbers of magnets, such as three magnets, may be used.

The hinge 108 may pivotably connect the first portion 104 and the second portion 106. To that end, the hinge 108 may include a pin 124, interlocking geometry, or the like. The hinge 108 may also include magnets configured to selectively retain the first portion 104 and second portion 106 in the first position or the second position.

The guide 110 may be a disc or pseudo-disc configured to be positioned in the first portion 104 for configuring the mount 100. The guide 110 may have an aperture 126 configured to align with the aperture 118 of the first portion 104 when the guide 110 is inserted into the first portion 104. The aperture 126 of the guide 110 may be smaller than the aperture 118 of the first portion 104 so that the mount 100 is particularly aligned with a lens 204 of the camera 202 when aided by the guide 110. In one embodiment, the guide 110 may have a gap 128 so that the guide 110 may flex slightly to fit the guide 110 in the first portion 104.

The target 112 may be a magnetic plate or disc configured to be positioned on a back side of the camera device 200. The target 112 may include a plurality of magnets 130A-C and an adhesive backing.

The magnets 130A-C may be arranged in a circularly array (appearing as a triangle). Three magnets 130A-C are shown but other numbers of magnets may be used depending on the number and spacing of magnets of the second portion 106 of the mount 100. The magnets 130A-C may be positioned to coincide with magnets 122A-C of the second portion 106 of the mount 100, as discussed in more detail below. The magnets 130A-C may have the same polarity as each other. In other embodiments, some magnets of the target 112 may have different polarities.

The adhesive backing may be configured to secure the target 112 to the back side of the camera device 200. The adhesive backing may be packaged with an adhesive backing cover for keeping the adhesive backing uncontaminated with debris and preventing the adhesive backing from prematurely adhering to objects.

Use of the mount 100 will now be described. First, the guide 110 may be inserted into the first portion 104. This may require the guide 110 to be flexed slightly to fit within the sidewall 116. This flexure may also retain the guide 110 in position. The target 112 may also be positioned on the second portion 106 such that the magnets 122A-C of the second portion 106 align with and attract the magnets 130A-C of the target. This may require the target 112 to be turned or rotated slightly, but advantageously, the magnets 122A-C will attract the magnets 130A-C while the magnets 122D-F will repel the magnets 130A-C. Thus, the target 112 will snap into alignment with the second portion 106. The adhesive backing cover may also be removed, exposing the adhesive backing.

With the target 112 aligned with and adhering to the second portion 106, the mount 100 may then be positioned near the back side of the camera device 200 such that the aperture 118 of the first portion 104 and the aperture 126 of the guide 110 align with the lens 204 of the camera 202 of the camera device 200. Importantly, the adhesive backing (and the entire mount 100 if necessary) should be slightly spaced from a camera side of the camera device 200 to prevent the adhesive backing from prematurely sticking to the camera side of the camera device 200.

The mount 100 may then be rotated about an axis extending through the apertures 118, 126 and the lens 204 of the camera 202 such that the target 112 is positioned over the back side of the camera device 200 (heretofore without the adhesive backing contacting the camera side of the camera device 200). At this point, the mount 100 is properly aligned with the camera device 200. Thus, the mount 100 may then be pressed toward the camera device 200 such that the adhesive backing adheres the target 112 to the camera side of the camera device 200.

The body 102 of the mount 100 may then be separated from the target 112. To that end, the body 102 may be pulled to overcome the magnetic attractive force between the magnets 122A-C and magnets 130A-C. In addition, or alternatively, the body 102 may be rotated or pivoted so that the repulsive force between magnets 122D-F and magnets 130A-C aid in separating the body 102 from the target 112. The guide 110 may also be removed from the first portion 104.

With the target 112 now being secured to the camera side of the camera device 200 and having been configured for alignment as described above, the mount 100 can easily be re-attached to the camera device 200 without further aligning or configuring necessary. The mount 100 may simply be positioned near the target 112 such that the magnets 122A-C and magnets 130A-C attract each other. The magnets 122D-F, being opposite polarity of magnets 130A-C, will urge the aperture 118 into proper alignment with the lens 204 of the camera 202 of the camera device 200. Note that the eyepiece of the optical device may be inserted into the first portion 104 of the mount 100 before or after the mount 100 is positioned near the target 112. After configuring the mount 100 and after reattaching the body 102 to the target 112, the camera 202 may be used to capture images or video via the optical device.

### Additional Considerations

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises”, “comprising”, “includes”, “including”, “has”, “having”, or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A mount for aligning an optical device with a camera via a target having a plurality of magnets, the camera having a lens, the mount comprising:
a body configured to engage the optical device, the body comprising:
a first portion including a sidewall and defining an aperture configured to be aligned with the lens of the camera; and
a second portion including a plurality of magnets including a first set of magnets having a first polarity and a second set of magnets having a second polarity opposite the first polarity such that the first set of magnets attract the plurality of magnets of the target and the second set of magnets repel the plurality of magnets of the target such that the aperture aligns with the lens of the camera.

2. The mount of claim 1, wherein the plurality of magnets of the second portion are arranged in a circular array.

3. The mount of claim 1, wherein the first set of magnets and the second set of magnets alternate such that each magnet of the first set of magnets is positioned adjacent to two magnets of the second set of magnets and each magnet of the second set of magnets is positioned adjacent to two magnets of the first set of magnets.

4. The mount of claim 1, wherein the second portion is movable with respect to the first portion between a first position in which the second portion covers the aperture and a second position in which the second portion extends away from the aperture.

5. The mount of claim 1, further comprising a guide including an aperture and configured to be encircled by the sidewall such that the aperture of the guide aligns with the aperture of the first portion for target.

6. The mount of claim 5, wherein the guide defines a gap extending to the aperture such that the guide is configured to flex to be encircled by the sidewall.

7. The mount of claim 1, wherein each of the first set of magnets and the second set of magnets includes three magnets such that the plurality of magnets of the second portion includes six magnets.

8. A mount for aligning an optical device with a camera device including a camera having a lens, the mount comprising:
a target including a plurality of magnets and configured to be attached to the camera device; and
a body configured to engage the optical device, the body comprising:
a first portion including a sidewall and defining an aperture configured to be aligned with the lens of the camera; and
a second portion including a plurality of magnets including a first set of magnets having a first polarity and a second set of magnets having a second polarity opposite the first polarity such that the first set of magnets attract the plurality of magnets of the target and the second set of magnets repel the plurality of magnets of the target so that the aperture aligns with the lens of the camera.

9. The mount of claim 8, wherein the target further includes an adhesive backing for attaching the target to the camera device.

10. The mount of claim 8, wherein the plurality of magnets of the second portion are arranged in a circular array.

11. The mount of claim 8, wherein the first set of magnets and the second set of magnets alternate such that each magnet of the first set of magnets is positioned adjacent to two magnets of the second set of magnets and each magnet of the second set of magnets is positioned adjacent to two magnets of the first set of magnets.

12. The mount of claim 8, wherein the second portion is movable with respect to the first portion between a first position in which the second portion covers the aperture and a second position in which the second portion is spaced from the aperture.

13. The mount of claim 12, further comprising a guide including an aperture and configured to be encircled by the sidewall such that the aperture of the guide aligns with the aperture of the first portion for target.

14. The mount of claim 13, wherein the guide defines a gap extending to the aperture such that the guide is configured to flex to be encircled by the sidewall.

15. The mount of claim 8, wherein each of the first set of magnets and the second set of magnets includes three magnets such that the plurality of magnets of the second portion includes six magnets.

16. The mount of claim 8, wherein each of the plurality of magnets of the target has a thickness of approximately 1/16 inch.

17. The mount of claim 16, wherein the plurality of magnets of the target includes three magnets.

18. A method of configuring a mount for aligning an optical device with a camera device, the method comprising steps of:
magnetically attaching a body of the mount to a target;
aligning an aperture of the body of the mount with a lens of a camera of the camera device;
adjusting the body of the mount so that the target is near a side of the camera device while the aperture remains aligned with the lens;
adhering the target to the side of the camera device;
detaching the body of the mount from the target; and
magnetically reattaching the body of the mount to the target so that the aperture automatically re-aligns with the lens.

19. The method of claim 18, wherein at least one of the body of the mount and the target comprises a plurality of magnets including a first set of magnets having a first polarity and a second set of magnets having a second polarity.

20. The method of claim 18, further comprising a step of aligning an aperture of a guide with the aperture of the body of the mount, the aperture of the guide being smaller than the aperture of the body of the mount, wherein the step of aligning the aperture of the body of the mount with the lens includes aligning the aperture of the guide with the lens.
